(19) United States
(12) Patent Application Publication
(10) Pub. No.: US 2026/0132822 A1
(43) Pub. Date: May 14, 2026

(54) CONSTANT VELOCITY JOINT ASSEMBLY

(71) Applicant: HYUNDAI WIA Corporation, Changwon-si (KR)

(72) Inventor: Chung Heon HYUN, Uiwang-si (KR)

(73) Assignee: HYUNDAI WIA Corporation, Changwon-si (KR)

(21) Appl. No.: 19/379,218

(22) Filed: Nov. 4, 2025

(30) Foreign Application Priority Data
Nov. 8, 2024 (KR) 10-2024-0157689

(51) Int. Cl. F16D 3/223

(52) U.S. Cl. CPC F16D 3/223; F16D 2003/22313; F16D 2300/06

(57) ABSTRACT

Disclosed is a constant velocity joint assembly. The constant velocity joint assembly includes a first constant velocity joint including a first outer race and a first shaft, a second constant velocity joint including a second outer race and a second shaft, a link including a plate-shaped portion disposed between the first outer race and the second outer race, a first coupling portion configured to allow an end portion of the first shaft to be engaged therewith, and a second coupling portion configured to allow an end portion of the second shaft to be engaged therewith, and a lubrication element for grease lubrication of the link.

### CROSS-REFERENCE TO THE RELATED APPLICATION

The present application claims priority to and the benefit of Korean Patent Application No. 10-2024-0157689, filed on Nov. 8, 2024, in the Korean Intellectual Property Office, the entire disclosure of which is incorporated herein by reference.

### BACKGROUND

### 1. Field

The present disclosure relates to a constant velocity joint assembly.

### 2. Description of the Related Art

A constant velocity joint is used to transmit rotational power between a driving shaft and a driven shaft disposed at an angle with respect thereto without a change in angular velocity. In order to implement a higher articulation angle, a structure in which two constant velocity joints are combined has been proposed. Such a structure is disclosed, for example, in U.S. Pat. No. 3,017,755.

### SUMMARY

An aspect of the present disclosure is to provide a constant velocity joint assembly capable of improving durability and operability.

A constant velocity joint assembly according to the present disclosure includes a first constant velocity joint including a first outer race and a first shaft, a second constant velocity joint including a second outer race and a second shaft, a link including a plate-shaped portion disposed between the first outer race and the second outer race, a first coupling portion configured to allow an end portion of the first shaft to be engaged therewith, and a second coupling portion configured to allow an end portion of the second shaft to be engaged therewith, and a lubrication element for grease lubrication of the link.

The lubrication element may include a lubrication groove formed in at least one of a contact surface between the first outer race and the plate-shaped portion or a contact surface between the second outer race and the plate-shaped portion.

The lubrication groove may be formed in one surface or both surfaces of the plate-shaped portion.

The first outer race may include a receiving recess formed therein to allow the plate-shaped portion to be seated therein, and the lubrication groove may be formed in the receiving recess in the first outer race.

The lubrication groove may be formed in a circular shape.

The lubrication groove may be formed in a concentric pattern.

The lubrication groove may be formed in a radial pattern.

The lubrication groove may be formed in a combination of concentric and radial patterns.

The lubrication element may include a lubrication hole allowing the inside of at least one of the first coupling portion or the second coupling portion to communicate with the outside.

The plate-shaped portion may have a hollow center to allow the inside of the first coupling portion and the inside of the second coupling portion to communicate with each other.

The lubrication hole may penetrate the plate-shaped portion to extend from the outer circumferential surface of the plate-shaped portion to the inner circumferential surface of the plate-shaped portion.

The lubrication hole may include a section penetrating the plate-shaped portion in a radial direction.

The lubrication hole may penetrate the first coupling portion to extend from the outer circumferential surface of the first coupling portion to the inner circumferential surface of the first coupling portion.

The lubrication hole may be provided in plural, and the plurality of lubrication holes may be arranged in a circumferential direction.

The first constant velocity joint may further include a first inner race coupled to the first shaft and disposed inside the first outer race and a first ball disposed between the first inner race and the first outer race, and the second constant velocity joint may further include a second inner race coupled to the second shaft and disposed inside the second outer race and a second ball disposed between the second inner race and the second outer race. The end portion of the first shaft may have a portion that is in direct contact with the first coupling portion during articulating motion and is formed in a spherical shape, and the end portion of the second shaft may have a portion that is in direct contact with the second coupling portion during articulating motion and is formed in a spherical shape. The constant velocity joint assembly may satisfy at least one of the following parameter relationships.

$$1. 005 \leq A / B \leq 1.02 \\ 1. 005 \leq C / D \leq 1.02$$

Here, A represents the inner diameter of the first coupling portion, B represents the diameter of the spherical portion of the end portion of the first shaft, C represents the inner diameter of the second coupling portion, and D represents the diameter of the spherical portion of the end portion of the second shaft.

The constant velocity joint assembly may further satisfy at least one of the following parameter relationships.

$$0.2 \leq E / F \leq 0.3 \\ 0.2 \leq E / G \leq 0.3$$

Here, E represents a distance between the center of the spherical portion of the end portion of the first shaft and the center of the spherical portion of the end portion of the second shaft, F represents the pitch circle diameter (PCD) of the first constant velocity joint, and G represents the pitch circle diameter (PCD) of the second constant velocity joint.

The constant velocity joint assembly may further satisfy at least one of the following parameter relationships.

$$1. 0 \leq H / F \leq 1.1 \\ 1. 0 \leq H / G \leq 1.1$$

Here, F represents the pitch circle diameter (PCD) of the first constant velocity joint, G represents the pitch circle diameter (PCD) of the second constant velocity joint, and H represents a distance between the articulation center of the first constant velocity joint and the articulation center of the second constant velocity joint.

### BRIEF DESCRIPTION OF THE DRAWINGS

The accompanying drawings, which are incorporated in this specification, illustrate exemplary embodiments and serve to further illustrate the technical ideas of the disclosure in conjunction with the detailed description of exemplary embodiments that follows, and the disclosure is not to be construed as limited to what is shown in such drawings. In the drawings:

FIG. 1 is a cross-sectional view of a constant velocity joint assembly according to an embodiment of the present disclosure;

FIG. 2 is a view showing parameters defined in the constant velocity joint assembly according to the embodiment of the present disclosure;

FIG. 3 is a perspective view of a link of the constant velocity joint assembly according to an embodiment of the present disclosure;

FIG. 4 is a side view of the link of the constant velocity joint assembly according to the embodiment of the present disclosure;

FIG. 5 is a side view of a link of the constant velocity joint assembly according to another embodiment of the present disclosure;

FIG. 6 is a side view of a link of the constant velocity joint assembly according to still another embodiment of the present disclosure;

FIG. 7 is a perspective view of a first outer race of the constant velocity joint assembly according to an embodiment of the present disclosure;

FIG. 8 is a side view of the first outer race of the constant velocity joint assembly according to the embodiment of the present disclosure;

FIG. 9 is a side view of a first outer race of the constant velocity joint assembly according to another embodiment of the present disclosure;

FIG. 10 is a side view of a first outer race of the constant velocity joint assembly according to still another embodiment of the present disclosure; and

FIG. 11 is a cross-sectional view of the link of the constant velocity joint assembly according to the embodiment of the present disclosure.

### DETAILED DESCRIPTION OF EXEMPLARY EMBODIMENTS

A constant velocity joint assembly 100 according to an embodiment of the present disclosure will be described in detail with reference to the accompanying drawings.

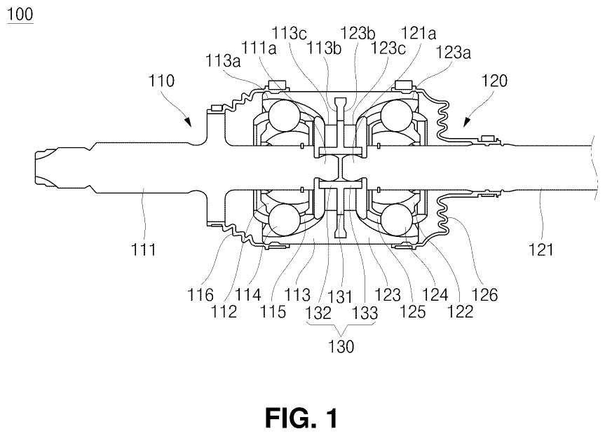

FIG. 1 is a cross-sectional view of the constant velocity joint assembly 100 according to an embodiment of the present disclosure.

Referring to FIG. 1, the constant velocity joint assembly 100 according to an embodiment of the present disclosure may include a first constant velocity joint 110, a second constant velocity joint 120, and a link 130.

The first constant velocity joint 110 may include a first shaft 111, a first inner race 112, a first outer race 113, a first ball 114, a first cage 115, and a first boot 116.

The first shaft 111 may be connected, for example, to a wheel hub side of a vehicle. An end portion 111a of the first shaft 111 may be inserted into and engaged with a first coupling portion 132 of the link 130. The end portion 111a of the first shaft 111 may be at least partially formed in a spherical shape in order to easily perform articulating motion in a state of being inserted into and engaged with the first coupling portion 132 of the link 130. For example, at least part of the end portion 111a of the first shaft 111 that is in direct contact with the first coupling portion 132 of the link 130 during articulating motion may be formed in a spherical shape. For example, part of the end portion 111a of the first shaft 111 that is not intended to directly contact the first coupling portion 132 of the link 130 during articulating motion may be formed in a spherical shape, like the aforementioned part, or may be eliminated for reduction in volume and weight. In the drawings, the tip of the end portion 111a of the first shaft 111 is illustrated as being flattened.

The first inner race 112 may be coupled to the first shaft 111. The first inner race 112 may include a groove formed in an outer circumferential surface thereof to allow the first ball 114 to be seated therein. The groove in the first inner race 112 may extend in the axial direction of the first inner race 112. Depending on the type of constant velocity joint, the groove 112 in the first inner race 112 may extend in a straight-line shape (sliding type) or may extend in a curved-line shape or in a combination of a straight-line shape and a curved-line shape (fixed type). In the drawings, the first constant velocity joint 110 is illustrated as being implemented as a fixed type, and the groove in the first inner race 112 is illustrated as extending in a curved-line shape. In other embodiments, the first constant velocity joint 110 may be implemented as a sliding type. In some embodiments, the groove in the first inner race 112 may be provided in plural, and the plurality of grooves may be arranged in the circumferential direction of the first inner race 112.

The first outer race 113 may include an internal space 113a defined therein to accommodate the first inner race 112, the first ball 114, and the first cage 115. The first outer race 113 may include a groove formed in an inner circumferential surface thereof to allow the first ball 114 to be seated therein. The groove in the first outer race 113 may extend in the axial direction of the first outer race 113. Similar to the groove in the first inner race 112, the groove in the first outer race 113 may extend in a straight-line shape or may extend in a curved-line shape or in a combination of a straight-line shape and a curved-line shape depending on the type of constant velocity joint. Because the first constant velocity joint 110 is implemented as a fixed type and the groove in the first inner race 112 extends in a curved-line shape, the groove in the first outer race 113 is illustrated in the drawings as extending in a curved-line shape corresponding to the groove in the first inner race 112. In some embodiments, the groove in the first outer race 113 may be provided in plural, and the plurality of grooves may be arranged in the circumferential direction of the first outer race 113.

The first outer race 113 may include a receiving recess 113b formed in a surface thereof (a right surface of the first outer race 113 based on the drawings) that faces a second outer race 123 of the second constant velocity joint 120 to allow a plate-shaped portion 131 of the link 130 to be seated therein. The receiving recess 113b may be recessed in the surface of the first outer race 113 so as to be stepped with respect to the surface of the first outer race 113. The receiving recess 113b may be formed to have a depth corresponding to half of the thickness of the plate-shaped portion 131 of the link 130. The receiving recess 113b may have a larger area than the plate-shaped portion 131 of the link 130. This allows the plate-shaped portion 131 of the link 130 to move within a region of the receiving recess 113b.

In some embodiments, the first outer race 113 may have a through-hole 113c, through which the internal space 113a and the receiving recess 113b communicate with each other. The end portion 111a of the first shaft 111 and the first coupling portion 132 of the link 130 may meet and be engaged with each other through the through-hole 113c.

The first ball 114 may be disposed between the groove in the first inner race 112 and the groove in the first outer race 113.

The first cage 115 may serve to restrain the first ball 114.

The first boot 116 may extend between the first shaft 111 and the first outer race 113. The first boot 116 may serve not only to prevent foreign substances from entering the internal space in the first outer race 113 from the outside but also to prevent a lubricant (grease) from leaking from the internal space in the first outer race 113 to the outside.

The second constant velocity joint 120 may be disposed opposite the first constant velocity joint 110.

The second constant velocity joint 120 may include a second shaft 121, a second inner race 122, a second outer race 123, a second ball 124, a second cage 125, and a second boot 126.

The second shaft 121 may be connected, for example, to an engine side, a motor side, or a transmission side of the vehicle. An end portion 121a of the second shaft 121 may be inserted into and engaged with a second coupling portion 133 of the link 130. The end portion 121a of the second shaft 121 may be at least partially formed in a spherical shape in order to easily perform articulating motion in a state of being inserted into and engaged with the second coupling portion 133 of the link 130. For example, at least part of the end portion 121a of the second shaft 121 that is in direct contact with the second coupling portion 133 of the link 130 during articulating motion may be formed in a spherical shape. For example, part of the end portion 121a of the second shaft 121 that is not intended to directly contact the second coupling portion 133 of the link 130 during articulating motion may be formed in a spherical shape, like the aforementioned part, or may be eliminated for reduction in volume and weight. In the drawings, the tip of the end portion 121a of the second shaft 121 is illustrated as being flattened.

The second inner race 122 may be coupled to the second shaft 121. The second inner race 122 may include a groove formed in an outer circumferential surface thereof to allow the second ball 124 to be seated therein. The groove in the second inner race 122 may extend in the axial direction of the second inner race 122. Depending on the type of constant velocity joint, the groove 122 in the second inner race 122 may extend in a straight-line shape or may extend in a curved-line shape or in a combination of a straight-line shape and a curved-line shape. In the drawings, the second constant velocity joint 120 is illustrated as being implemented as a fixed type, and the groove in the second inner race 122 is illustrated as extending in a curved-line shape. In other embodiments, the second constant velocity joint 120 may be implemented as a sliding type. In some embodiments, the groove in the second inner race 122 may be provided in plural, and the plurality of grooves may be arranged in the circumferential direction of the second inner race 122.

The second outer race 123 may include an internal space 123a defined therein to accommodate the second inner race 122, the second ball 124, and the second cage 125. The second outer race 123 may include a groove formed in an inner circumferential surface thereof to allow the second ball 124 to be seated therein. The groove in the second outer race 123 may extend in the axial direction of the second outer race 123. Similar to the groove in the second inner race 122, the groove in the second outer race 123 may extend in a straight-line shape or may extend in a curved-line shape or in a combination of a straight-line shape and a curved-line shape depending on the type of constant velocity joint. Because the second constant velocity joint 120 is implemented as a fixed type and the groove in the second inner race 122 extends in a curved-line shape, the groove in the second outer race 123 is illustrated in the drawings as extending in a curved-line shape corresponding to the groove in the second inner race 122. In some embodiments, the groove in the second outer race 123 may be provided in plural, and the plurality of grooves may be arranged in the circumferential direction of the second outer race 123.

The second outer race 123 may include a receiving recess 123b formed in a surface thereof (a left surface of the second outer race 123 based on the drawings) that faces the first outer race 113 of the first constant velocity joint 110 to allow the plate-shaped portion 131 of the link 130 to be seated therein. The receiving recess 123b may be recessed in the surface of the second outer race 123 so as to be stepped with respect to the surface of the second outer race 123. The receiving recess 123b may be formed to have a depth corresponding to half of the thickness of the plate-shaped portion 131 of the link 130. The receiving recess 123b may have a larger area than the plate-shaped portion 131 of the link 130. This allows the plate-shaped portion 131 of the link 130 to move within a region of the receiving recess 123b.

In some embodiments, the second outer race 123 may have a through-hole 123c, through which the internal space 123a and the receiving recess 123b communicate with each other. The end portion 121a of the second shaft 121 and the second coupling portion 133 of the link 130 may meet and be engaged with each other through the through-hole 123c.

The first outer race 113 and the second outer race 123 may be integrally formed with each other or may be separately fabricated and coupled to each other, for example, using welding or bolting. For example, if the first outer race 113 and the second outer race 123 are coupled to each other using welding, one surface of the first outer race 113 and one surface of the second outer race 123 may be disposed in contact with each other, and then welding may be performed along the boundary therebetween. In other embodiments, if the first outer race 113 and the second outer race 123 are coupled to each other using bolting, the first outer race 113 may be formed to have a protruding portion protruding radially outward from one surface thereof, the second outer race 123 may be formed to have a protruding portion protruding radially outward from one surface thereof, and a bolt may be fastened to the protruding portion of the first outer race 113 and the protruding portion of the second outer race 123 to secure the same to each other.

The second ball 124 may be disposed between the groove in the second inner race 122 and the groove in the second outer race 123.

The second cage 125 may serve to restrain the second ball 124.

The second boot 126 may extend between the second shaft 121 and the second outer race 123. The second boot 126 may serve not only to prevent foreign substances from entering the internal space in the second outer race 123 from the outside but also to prevent a lubricant (grease) from leaking from the internal space in the second outer race 123 to the outside.

The link 130 may serve to interconnect the first shaft 111 of the first constant velocity joint 110 and the second shaft 121 of the second constant velocity joint 120.

For example, the link 130 may include a plate-shaped portion 131, a first coupling portion 132, and a second coupling portion 133.

The plate-shaped portion 131 may be formed in a plate shape, for example, a disc shape, and may be slidably mounted in a space defined by the receiving recess 113b in the first outer race 113 and the receiving recess 123b in the second outer race 123.

The first coupling portion 132 may extend in a hollow cylindrical shape from a surface of the plate-shaped portion 131 (a left surface of the plate-shaped portion 131 based on the drawings) that faces the first constant velocity joint 110. The end portion 111a of the first shaft 111 may be inserted into and engaged with the first coupling portion 132, so that the first shaft 111 may be coupled to the link 130.

The second coupling portion 133 may extend in a hollow cylindrical shape from a surface of the plate-shaped portion 131 (a right surface of the plate-shaped portion 131 based on the drawings) that faces the second constant velocity joint 120. The end portion 121a of the second shaft 121 may be inserted into and engaged with the second coupling portion 133, so that the second shaft 121 may be coupled to the link 130.

The first coupling portion 132 and the second coupling portion 133 may be formed symmetrically with respect to the plate-shaped portion 131. For example, the first coupling portion 132 and the second coupling portion 133 may be disposed coaxially. In some embodiments, the first coupling portion 132 and the second coupling portion 133 may be formed to have the same dimension (such as inner diameter, outer diameter, and length).

The first coupling portion 132 and/or the second coupling portion 133 may be integrally formed with the plate-shaped portion 131.

The interior of the first coupling portion 132 and the interior of the second coupling portion 133 may communicate with each other. For example, the plate-shaped portion 131 may be formed to have a hollow center.

During articulating motion, if the distance between the articulation center of the first constant velocity joint 110 and the center of the plate-shaped portion 131 of the link 130 is equal to the distance between the articulation center of the second constant velocity joint 120 and the center of the plate-shaped portion 131 of the link 130, the articulation angle of the first constant velocity joint 110 and the articulation angle of the second constant velocity joint 120 may be equal.

If the distance between the articulation center of the first constant velocity joint 110 and the center of the plate-shaped portion 131 of the link 130 is greater than the distance between the articulation center of the second constant velocity joint 120 and the center of the plate-shaped portion 131 of the link 130, the articulation angle of the first constant velocity joint 110 may become less than the articulation angle of the second constant velocity joint 120.

If the distance between the articulation center of the second constant velocity joint 120 and the center of the plate-shaped portion 131 of the link 130 is greater than the distance between the articulation center of the first constant velocity joint 110 and the center of the plate-shaped portion 131 of the link 130, the articulation angle of the second constant velocity joint 120 may become less than the articulation angle of the first constant velocity joint 110.

The present disclosure may encompass all of the aforementioned cases.

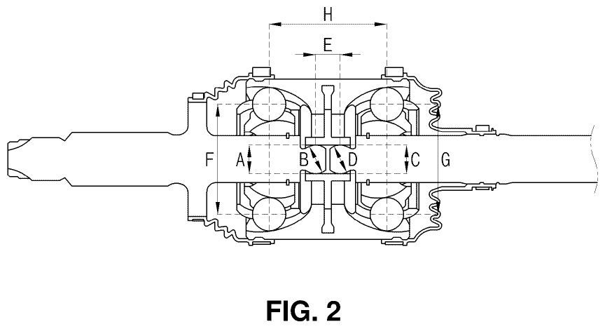

In the present disclosure, the following parameters may be defined as shown in FIG. 2.
A: inner diameter of the first coupling portion 132 of the link 130
B: diameter of the spherical portion of the end portion 111a of the first shaft 111
C: inner diameter of the second coupling portion 133 of the link 130
D: diameter of the spherical portion of the end portion 121a of the second shaft 121
E: distance between the center of the spherical portion of the end portion 111a of the first shaft 111 and the center of the spherical portion of the end portion 121a of the second shaft 121
F: pitch circle diameter (PCD) of the first constant velocity joint 110
G: pitch circle diameter (PCD) of the second constant velocity joint 120
H: distance between the articulation center of the first constant velocity joint 110 and the articulation center of the second constant velocity joint 120

The above parameters may have the following relationships.

$$1. 005 \leq A / B \leq 1.02 \\ 1. 005 \leq C / D \leq 1.02 \\ 0.2 \leq E / F \leq 0.3 \\ 0.2 \leq E / G \leq 0.3 \\ 1. 0 \leq H / F \leq 1.1 \\ 1. 0 \leq H / G \leq 1.1$$

As mentioned above, it may be advantageous that A/B be equal to or greater than 1.005. If A/B is less than 1.005, internal pressure in the first coupling portion 132 of the link 130 may increase, which may adversely affect operability (articulation angle variation). It may also be advantageous that A/B be equal to or less than 1.020. If A/B exceeds 1.020, contact surface pressure may increase, resulting in excessive damage due to wear.

Similarly, it may be advantageous that C/D be equal to or greater than 1.005. If C/D is less than 1.005, internal pressure in the second coupling portion 133 of the link 130 may increase, which may adversely affect operability (articulation angle variation). It may also be advantageous that C/D be equal to or less than 1.020. If C/D exceeds 1.020, contact surface pressure may increase, resulting in excessive damage due to wear.

It may be advantageous that E/F and/or E/G be equal to or greater than 0.2. If E/F and/or E/G is less than 0.2, the dimension of the corresponding outer race 113 or 123 in the radial direction may become relatively excessive, and the corresponding constant velocity joint 110 or 120 may be excessively increased in capacity (i.e., oversized), which may adversely affect the weight, packaging, and cost of the product and may reduce the strength of the neck portion of the end portion 111a or 121a of the corresponding shaft 111 or 121. It may also be advantageous that E/F and/or E/G be equal to or less than 0.3. If E/F and/or E/G exceeds 0.3, the length of the corresponding outer race 113 or 123 in the axial direction may become relatively excessive, and the corresponding constant velocity joint 110 or 120 may be excessively reduced in capacity (i.e., undersized), which may adversely affect the strength and durability of the components and may reduce the strength of the link 130.

It may be advantageous that H/F and/or H/G be equal to or greater than 1.0. If H/F and/or H/G is less than 1.0, the dimension of the corresponding outer race 113 or 123 in the radial direction may become relatively excessive, and the corresponding constant velocity joint 110 or 120 may be excessively increased in capacity (i.e., oversized), which may adversely affect the weight, packaging, and cost of the product and may reduce the strength of the neck portion of the end portion 111a or 121a of the corresponding shaft 111 or 121. It may also be advantageous that H/F and/or H/G be equal to or less than 1.1. If H/F and/or H/G exceeds 1.1, the length of the corresponding outer race 113 or 123 in the axial direction may become relatively excessive, and the corresponding constant velocity joint 110 or 120 may be excessively reduced in capacity (i.e., undersized), which may adversely affect the strength and durability of the components and may reduce the strength of the link 130.

By designing the parameters such as E/F, E/G, H/F, and H/G as described above, it may be possible to minimize the outer diameter, weight, and cost of the product while securing a sufficient level of component strength and durability.

The present disclosure may include a lubrication groove for grease lubrication, which is formed in a contact surface between the receiving recess 113b in the first outer race 113 and the plate-shaped portion 131 of the link 130 and/or a contact surface between the receiving recess 123b in the second outer race 123 and the plate-shaped portion 131 of the link 130.

For example, the lubrication groove may be formed in one surface or both surfaces of the plate-shaped portion 131 of the link 130.

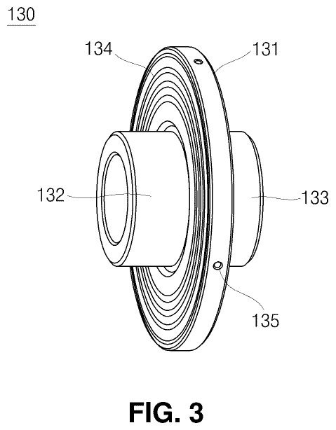

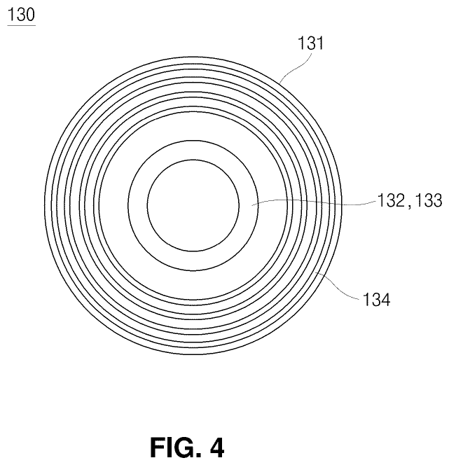

In one embodiment, as shown in FIGS. 3 and 4, the lubrication groove 134 may be formed in the plate-shaped portion 131 in the circumferential direction and may have a circular shape. The lubrication groove 134 may be provided in plural, and the plurality of lubrication grooves 134 may be formed in a concentric pattern.

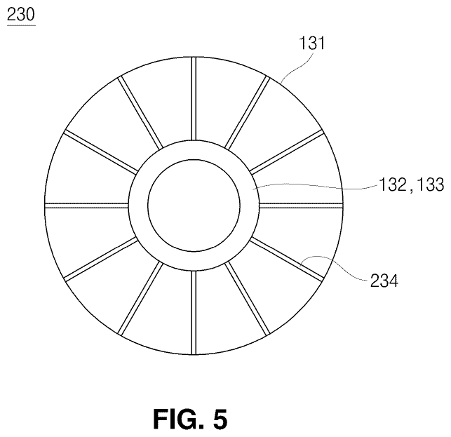

In another embodiment of the link 230, as shown in FIG. 5, the lubrication grooves 234 may be formed in the plate-shaped portion 131 in the radial direction, that is, in a radial pattern.

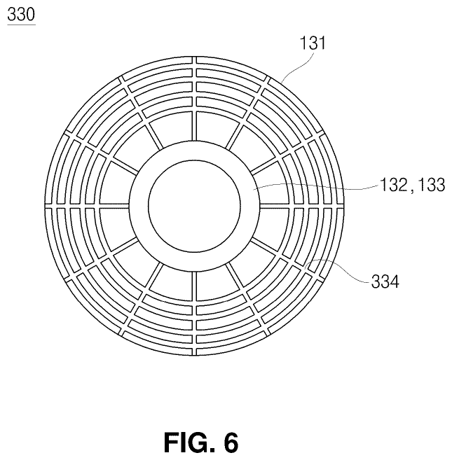

In still another embodiment of the link 330, as shown in FIG. 6, the lubrication grooves 334 may be formed in a combination of concentric and radial patterns.

Alternatively or additionally, for example, the lubrication groove may be formed in a bottom surface of the receiving recess 113b in the first outer race 113.

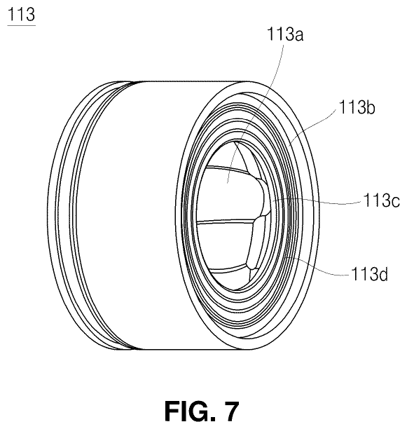

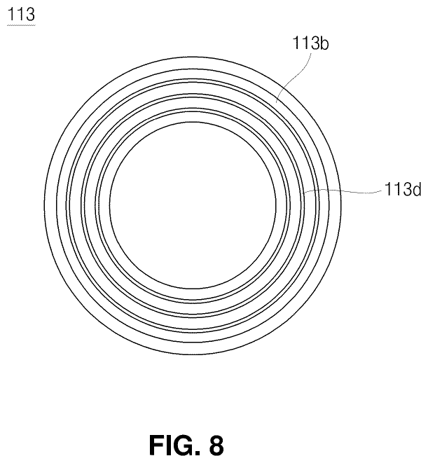

In one embodiment, as shown in FIGS. 7 and 8, the lubrication groove 113d may be formed in the receiving recess 113b in the first outer race 113 in the circumferential direction and may have a circular shape. The lubrication groove 113d may be provided in plural, and the plurality of lubrication grooves 113d may be formed in a concentric pattern.

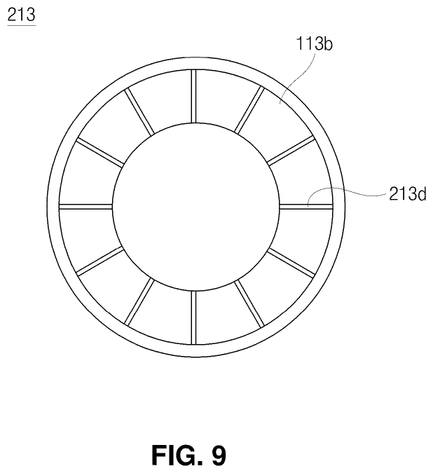

In another embodiment of the first outer race 213, as shown in FIG. 9, the lubrication grooves 213d may be formed in the receiving recess 113b in the first outer race 213 in the radial direction, that is, in a radial pattern.

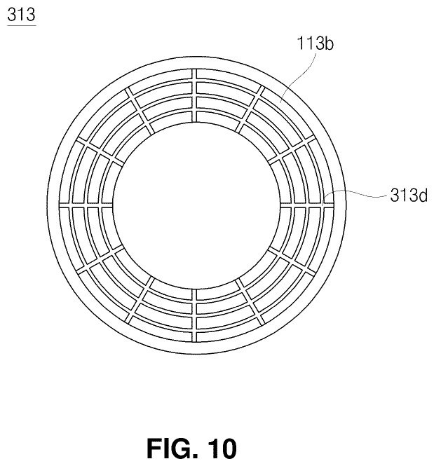

In still another embodiment of the first outer race 313, as shown in FIG. 10, the lubrication grooves 313d may be formed in a combination of concentric and radial patterns.

Alternatively or additionally, for example, the lubrication groove may be formed in a bottom surface of the receiving recess 123b in the second outer race 123. The configuration in which the lubrication groove is formed in the receiving recess 123b in the second outer race 123 may be substantially the same as the configuration in which the lubrication groove 113d, 213d, or 313d is formed in the receiving recess 113b in the first outer race 113, 213, or 313, which has been described above with reference to FIGS. 7, 8, 9, and 10, and thus redundant descriptions thereof will be omitted.

Grease may be uniformly distributed and may circulate through the above-described lubrication grooves between the plate-shaped portion of the link and the receiving recess in the first outer race and/or the second outer race, thereby preventing the grease from stagnating at a particular position or preventing the application of excessive pressure due to the stagnating grease during sliding of the link.

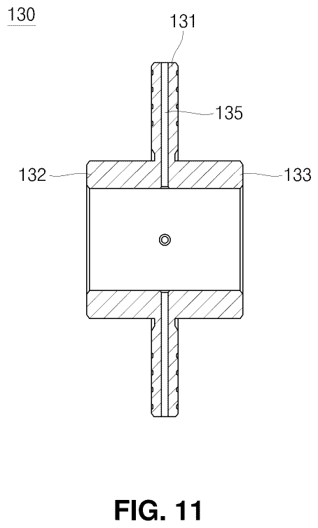

Referring also to FIG. 11, the present disclosure may include a lubrication hole 135 through which the inside of the first coupling portion 132 and/or the second coupling portion 133 of the link 130 communicates with the outside.

For example, the lubrication hole 135 may extend from the outer circumferential surface of the plate-shaped portion 131 of the link 130 to the inner circumferential surface of the plate-shaped portion 131 of the link 130 so as to penetrate the body of the plate-shaped portion 131 in the radial direction.

In the present disclosure, the lubrication hole 135 is not necessarily limited to the above-described structure. In another embodiment, the lubrication hole 135 may penetrate the body of the plate-shaped portion 131 from one surface or both surfaces of the plate-shaped portion 131, that is, may extend in the axial direction, and may then be bent to extend in the radial direction to the inner circumferential surface of the plate-shaped portion 131. In still another embodiment, the lubrication hole 135 may be formed in the first coupling portion 132 and/or the second coupling portion 133, rather than in the plate-shaped portion 131. For example, the lubrication hole 135 may extend from the outer circumferential surface of the first coupling portion 132 to the inner circumferential surface of the first coupling portion 132 while penetrating the first coupling portion 132 in the radial direction or may extend from the outer circumferential surface of the second coupling portion 133 to the inner circumferential surface of the second coupling portion 133 while penetrating the second coupling portion 133 in the radial direction.

Grease may be supplied to the inside of the first coupling portion 132 and/or the second coupling portion 133 of the link 130 through the above-described lubrication hole 135, thereby improving the durability and operability of the related components. Furthermore, it may be possible to respond to changes in internal pressure in the first coupling portion 132 and/or the second coupling portion 133 using the lubrication hole 135. For example, during articulating motion, the end portion 111a of the first shaft 111 may move within the first coupling portion 132, or the end portion 121a of the second shaft 121 may move within the second coupling portion 133, which may cause change in internal pressure in the first coupling portion 132 and/or the second coupling portion 133. Because the insides of the first coupling portion 132 and the second coupling portion 133 communicate with the outside through the lubrication hole 135, pressure may be released without being applied to the insides, thereby further improving the durability and operability of the related components.

Such a lubrication hole 135 may be provided in plural, and the plurality of lubrication holes 135 may be arranged radially in the circumferential direction.

The constant velocity joint assembly described above is merely one of various embodiments of the constant velocity joint assembly according to the present disclosure.

As is apparent from the above description, because the constant velocity joint assembly according to the present disclosure includes a lubrication groove for grease lubrication, which is formed in a contact surface between the receiving recess in the first outer race and the plate-shaped portion of the link and/or a contact surface between the receiving recess in the second outer race and the plate-shaped portion of the link, a lubricant or grease may be uniformly distributed and may circulate through the lubrication groove between the plate-shaped portion of the link and the receiving recess in the first outer race or the second outer race, thereby preventing the grease from stagnating at a particular position or preventing the application of excessive pressure due to the stagnating grease during sliding of the link.

Furthermore, because the inside of the first coupling portion and/or the inside of the second coupling portion of the link communicates with the outside through the lubrication hole, grease may be supplied to the inside of the first coupling portion and/or the inside of the second coupling portion of the link through the lubrication hole, thereby improving the durability and operability of related components.

Although the present disclosure has been described above with reference to the exemplary embodiments, the present disclosure is not limited thereto, and it should be understood that various changes and modifications can be made by those skilled in the art without departing from the spirit and scope of the disclosure as defined by the appended claims.

What is claimed is:

1. A constant velocity joint assembly comprising:
a first constant velocity joint comprising a first outer race and a first shaft;
a second constant velocity joint comprising a second outer race and a second shaft;
a link comprising a plate-shaped portion disposed between the first outer race and the second outer race, a first coupling portion configured to allow an end portion of the first shaft to be engaged therewith, and a second coupling portion configured to allow an end portion of the second shaft to be engaged therewith; and
a lubrication element for grease lubrication of the link.

2. The constant velocity joint assembly as claimed in claim 1, wherein the lubrication element comprises a lubrication groove formed in at least one of a contact surface between the first outer race and the plate-shaped portion or a contact surface between the second outer race and the plate-shaped portion.

3. The constant velocity joint assembly as claimed in claim 2, wherein the lubrication groove is formed in one surface or both surfaces of the plate-shaped portion.

4. The constant velocity joint assembly as claimed in claim 2, wherein the first outer race comprises a receiving recess formed therein to allow the plate-shaped portion to be seated therein, and
wherein the lubrication groove is formed in the receiving recess in the first outer race.

5. The constant velocity joint assembly as claimed in claim 2, wherein the lubrication groove is formed in a circular shape.

6. The constant velocity joint assembly as claimed in claim 2, wherein the lubrication groove is formed in a concentric pattern.

7. The constant velocity joint assembly as claimed in claim 2, wherein the lubrication groove is formed in a radial pattern.

8. The constant velocity joint assembly as claimed in claim 2, wherein the lubrication groove is formed in a combination of concentric and radial patterns.

9. The constant velocity joint assembly as claimed in claim 1, wherein the lubrication element comprises a lubrication hole allowing an inside of at least one of the first coupling portion or the second coupling portion to communicate with an outside thereof.

10. The constant velocity joint assembly as claimed in claim 9, wherein the plate-shaped portion has a hollow center to allow the inside of the first coupling portion and the inside of the second coupling portion to communicate with each other.

11. The constant velocity joint assembly as claimed in claim 9, wherein the lubrication hole penetrates the plate-shaped portion to extend from an outer circumferential surface of the plate-shaped portion to an inner circumferential surface of the plate-shaped portion.

12. The constant velocity joint assembly as claimed in claim 9, wherein the lubrication hole comprises a section penetrating the plate-shaped portion in a radial direction.

13. The constant velocity joint assembly as claimed in claim 9, wherein the lubrication hole penetrates the first coupling portion to extend from an outer circumferential surface of the first coupling portion to an inner circumferential surface of the first coupling portion.

14. The constant velocity joint assembly as claimed in claim 9, wherein the lubrication hole is provided in plural, and the plurality of lubrication holes is arranged in a circumferential direction.

15. The constant velocity joint assembly as claimed in claim 1, wherein the first constant velocity joint further comprises a first inner race coupled to the first shaft and disposed inside the first outer race and a first ball disposed between the first inner race and the first outer race,
wherein the second constant velocity joint further comprises a second inner race coupled to the second shaft and disposed inside the second outer race and a second ball disposed between the second inner race and the second outer race,
wherein the end portion of the first shaft has a portion in direct contact with the first coupling portion during articulating motion, and the portion in direct contact with the first coupling portion is formed in a spherical shape,
wherein the end portion of the second shaft has a portion in direct contact with the second coupling portion during articulating motion, and the portion in direct contact with the second coupling portion is formed in a spherical shape, and
wherein the constant velocity joint assembly satisfies at least one of following parameter relationships:
$$1. 005 \leq A / B \leq 1.02 \\ 1. 005 \leq C / D \leq 1.02$$
where A represents an inner diameter of the first coupling portion, B represents a diameter of the spherical portion of the end portion of the first shaft, C represents an inner diameter of the second coupling portion, and D represents a diameter of the spherical portion of the end portion of the second shaft.

16. The constant velocity joint assembly as claimed in claim 15, further satisfying at least one of following parameter relationships:
$$0.2 \leq E / F \leq 0.3 \\ 0.2 \leq E / G \leq 0.3$$
where E represents a distance between a center of the spherical portion of the end portion of the first shaft and a center of the spherical portion of the end portion of the second shaft, F represents a pitch circle diameter (PCD) of the first constant velocity joint, and G represents a pitch circle diameter (PCD) of the second constant velocity joint.

17. The constant velocity joint assembly as claimed in claim 15, further satisfying at least one of following parameter relationships:
$$1. 0 \leq H / F \leq 1.1 \\ 1. 0 \leq H / G \leq 1.1$$
where F represents a pitch circle diameter (PCD) of the first constant velocity joint, G represents a pitch circle diameter (PCD) of the second constant velocity joint, and H represents a distance between an articulation center of the first constant velocity joint and an articulation center of the second constant velocity joint.
